(19) United States
(12) Patent Application Publication
(10) Pub. No.: US 2011/0148345 A1
(43) Pub. Date: Jun. 23, 2011

(54) DEVICE AND METHOD FOR THE GENERATION, STORAGE, AND TRANSMISSION OF ELECTRIC ENERGY

(76) Inventors: Jens Böckermann, Stuttgart (DE); Stefan Heinbockel, Munchen (NL)

(21) Appl. No.: 12/737,904

(22) PCT Filed: Jul. 24, 2009
(86) PCT No.: PCT/EP2009/059533

§ 371 Date: Feb. 28, 2011

(30) Foreign Application Priority Data
Aug. 29, 2008 (DE) 10 2008 044 902.4

(51) Int. Cl. H02J 7/00

(52) U.S. Cl. 320/103

(57) ABSTRACT

A device for the generation, storage, and transmission of electric energy, includes an energy source, at least one first storage unit, and a second storage unit for storing energy, and a controller. The second storage unit is electrically connected to the first storage unit such that electrical energy of the second storage unit can be fed to the first storage unit for electrically charging the first storage unit.

### CROSS REFERENCE TO RELATED APPLICATIONS

This application is based on and hereby claims priority to International Application No. PCT/EP2009/059533 filed on Jul. 24, 2009 and German Application No. 10 2008 044 902.4 filed on Aug. 29, 2008, the contents of which are hereby incorporated by reference.

### BACKGROUND

The invention relates to a method and device for the generation, storage and transmission of electrical energy.

The related art has disclosed applications which can be operated independently of a power supply system. Such applications are suitable in particular for use in very remote and/or poorly accessible areas, for example in the case of sensor applications. In order to supply electrical energy to these applications, said applications can comprise so-called energy harvesting components, for example. In this case, energy harvesting refers to the conversion of energy from ambient sources such as ambient temperature, light, vibration or air flow. Since permanent energy generation is not possible by these energy harvesting components owing to the fact that ambient sources are not continuously present, the applications usually have storage units, by which the electrical energy generated by the energy harvesting components can be stored, with the result that a supply of electrical energy to the applications can be achieved even in the case of inactive energy harvesting components.

Such an application is known from WO 2007/082 168 A2, which discloses a device and a method for energy harvesting, for the generation, storage and transmission of energy to an electrical load, in particular for remote or inaccessible applications. The device preferably comprises one or more energy sources and, as storage units, at least one double-layer capacitor for supplying power to the electrical load and at least one rechargeable battery as emergency power supply. Furthermore, a control unit for controlling the device is provided. The storage of the energy, i.e. charging of the storage units and the transmission of the energy to said storage units, is preferably performed dynamically and variably, it being possible for the storage units to be charged when said storage units are not emitting any electrical energy. A charge pump is provided for electrically charging the double-layer capacitor, said charge pump collecting in particular electrical energy from low-power energy sources and at the same time enabling transmission of this energy with a higher electrical voltage to the electrical load.

Furthermore, an energy content of the storage units is monitored, with it being possible for a frequency to be set during charging of said storage units using the energy content. In addition, two double-layer capacitors can also be connected electrically in series or in parallel with one another.

In addition, WO 2005/091462 A1 has disclosed a device and a method for charging a rechargeable battery, a capacitive storage unit being charged with electrical energy to an electrical voltage which is higher than the rated voltage of the rechargeable battery. When a predetermined limit value for the voltage of the capacitive storage unit is reached, the electrical energy is discharged into the rechargeable battery.

US 2003/0117111 A1 has disclosed a device and a method for charging an electrical battery from an electrical energy source. In a first phase, a capacitive storage unit is charged with electrical energy. In a second phase, the capacitive storage unit is isolated from the energy source and the electrical battery is charged with electrical energy stored in the capacitive storage unit.

Furthermore, documents EP 1 542 099 A1, DE 199 13 627 A1 and US 2007/0096564 A1 have disclosed devices and methods, in which at least one energy storage unit is charged with electrical energy from an energy source and the stored energy is supplied to a second energy storage unit.

### SUMMARY

One possible object is to specify a device and a method for the generation, storage and transmission of electrical energy, which enables continuous operation of low-power electrical consumers with at the same time at least short-term supply of electrical energy to high-power electrical consumers.

The inventors propose a device for the generation, storage and/or transmission of electrical energy comprises at least one energy source, at least a first storage unit and a second storage unit for storing the energy and a control unit. In order to electrically charge the first storage unit, electrical energy from the second storage unit can be supplied to said first storage unit. Thus, it is advantageously also possible for storage units which require a predetermined minimum charging current for electrical charging to be charged.

According to the proposals, the energy source and the storage units are furthermore connected to electrical consumers of a distributed and autonomous device, wherein the electrical energy can be supplied to high-power electrical consumers (3) in the form of communication units by the first storage unit (4) and to low-power electrical consumers (2) in the form of sensors by the second storage unit (5), with a storage capacitance of the second storage unit being lower than that of the first storage unit.

It follows from this advantageously that electrical consumers in the form of sensors with a low energy requirement are very quickly ready for use since a voltage level which is necessary for operation of the sensors can be achieved early owing to the low storage capacitance and a resultant quick charging time of the second storage unit. It is thus furthermore possible for data detected by the sensors, for example environmental data, to be transmitted to a control center by the communication units.

The energy source is preferably an energy harvesting component, which enables autonomous supply to electrical, in particular remote and poorly accessible applications.

Since the energy harvesting component only has a low electrical power, the electrical energy generated can be supplied first to the second storage unit, in particular an electrolyte capacitor, in which no minimum charging current is required for charging, wherein, in a particularly advantageous development, the control unit comprises a charging circuit, by which the supply of electrical energy to the second storage unit and from said second storage unit to the first storage unit can be controlled. In this case, in particular, the charging current and/or a charging voltage can be controlled, with the result that storage of the electrical energy in the first storage unit is ensured.

In accordance with one configuration, the first storage unit and the second storage unit are of different types, with the first storage unit preferably being a double-layer capacitor which has a very high energy density instead of a conventional rechargeable battery, with the result that small installation areas are required.

Owing to the embodiment of the first storage unit as a double-layer capacitor and the second storage unit as an electrolyte capacitor, advantageously no rechargeable batteries for storing the electrical energy are required, with the result that it is possible to achieve an extension of the life of the device. Furthermore, temperature influences only have a small influence on the life of the capacitors. In addition, the capacitors are designed for a very large number of charging and discharging cycles. Furthermore, capacitors have the particular advantage over rechargeable batteries as energy stores that they contain fewer toxins than rechargeable batteries and therefore can be disposed of more easily.

In order to operate low-power electrical consumers using the second storage unit in different states of charge thereof, a voltage regulator is provided, by which it is possible for a voltage level for operating a low-power electrical consumer to be set automatically.

In a particularly advantageous development, the charging circuit comprises a switching regulator for charging the second storage unit, the switching regulator being a pulsed current source. Said pulsed current source has a very high efficiency and makes it possible for the double-layer capacitor to be charged to a higher electrical voltage than the electrolyte capacitor, with the result that it is possible to store additional energy. Furthermore, electrical energy can be supplied to the first storage unit, i.e. in particular the double-layer capacitor, and/or the second storage unit at the same time as energy is drawn.

In addition, a detection unit is provided, by which a state of charge of the storage units, in particular the second storage unit, can be detected. It is thus possible in an advantageous manner for a sufficient quantity of electrical energy always to be available for operating low-power electrical consumers.

In addition, the device for the generation, storage and/or transmission of electrical energy is intended for use for supplying electrical power to distributed devices, in particular control devices, sensors, sensor networks, transmitters, receivers, assemblies and/or drives, with the result that independent operation of these devices from the power supply systems is possible.

By way of summary, the device and the method and configurations thereof enable continuous operation of the low-power electrical consumers with at the same time at least short-term supply of electrical energy to the high-power electrical consumers. Owing to the fact that the storage units are split, sufficient energy can be provided with a necessary minimum voltage level.

### BRIEF DESCRIPTION OF THE DRAWING

These and other objects and advantages of the present invention will become more apparent and more readily appreciated from the following description of the preferred embodiments, taken in conjunction with the accompanying drawing of which:

FIG. 1 shows a schematic of a block circuit diagram of a device for the generation, storage and/or transmission of electrical energy, comprising at least an energy source, which is in the form of an energy harvesting element.

### DETAILED DESCRIPTION OF THE PREFERRED EMBODIMENT

Reference will now be made in detail to the preferred embodiments of the present invention, examples of which are illustrated in the accompanying drawing, wherein like reference numerals refer to like elements throughout.

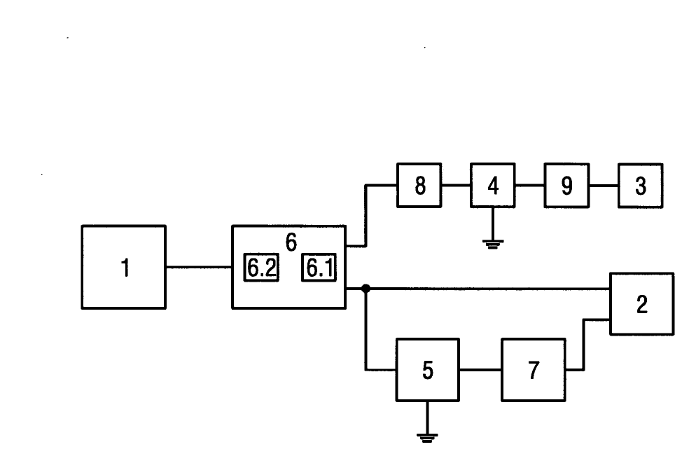

The single figure, FIG. 1, illustrates a device for the generation, storage and/or transmission of electrical energy, comprising at least one energy source 1, which is in the form of an energy harvesting element. Both the device and the method proposed by the inventors as well as advantageous configurations thereof will be described below with reference to FIG. 1.

In this case, the device is intended in particular for applications which are located in poorly accessible areas and are independent of a power supply system.

The energy source 1, i.e. the energy harvesting element, may be a solar cell, a piezoelectric arrangement, a thermoelectric generator or further conceivable energy sources, for example, which generate electrical energy from ambient sources such as ambient temperature, light, vibration or air flow. In an exemplary embodiment which is not illustrated in any more detail, a plurality of energy sources 1 are provided, wherein the energy sources 1 preferably generate electrical energy from various ambient sources. Thus, the probability that no electrical energy can be generated because there is no ambient source available is reduced.

Since energy harvesting elements generally generate a low electrical power which can be drawn, these elements are suitable in particular for applications with a low electrical energy requirement or a low electrical power consumption. In particular sensor applications, for example for detecting environmental data, come under consideration here.

Therefore, the device furthermore comprises, as low-power electrical consumers 2, one or more sensors, which may be temperature sensors, acceleration sensors, gas sensors or further sensors, for example. Said sensors only require a low electrical power during operation and are often intended to be operated independently of a power supply system since energy supply wiring is undesirable, for example in industrial plants in large numbers.

Furthermore, the autonomous supply of electrical energy to the sensors makes it possible for said sensors to be supplied with electrical energy even in poorly accessible areas for example in earthquake regions.

Given such an application of the device for supplying electrical energy to an arrangement for detecting earthquakes, a large number of sensors, in particular vibration sensors, or sensor networks can be supplied with electrical energy by the energy source 1 independently of a power supply system. The vibration sensors are in this case arranged preferably in such a way that communication, i.e. data interchange, between said sensors is possible, with the result that, for example, an alarm can be triggered in the event of a vibration being detected by a plurality of sensors.

Furthermore, the device is also suitable for supplying electrical power to arrangements for monitoring other environmental parameters, for example for measuring a water quality in ground water or for detecting woodland fires. Owing to a supply of energy to such arrangements by the device for the generation, storage and/or transmission of electrical energy, reliable operation and supply of electricity can advantageously be realized over very long periods of time, in particular several years.

A further possible intended use is the use of the device for supplying energy to electrical entertainment devices, for example television sets or music systems. In this case, a thermogenerator could preferably be provided for converting heat from a user's hand into electrical energy and is released on actuation of a pushbutton, with the result that generally used batteries or rechargeable batteries for the supply of energy can be dispensed with.

In order to evaluate the data detected by the sensors, for example in a control center, the device furthermore comprises at least one communication unit as high-power electrical consumer 3, it being possible for said communication unit to be used to transmit the detected data to the control center. Depending on the application, various data transmission systems and/or standards, such as GSM (Global System for Mobile Communications), WLAN (Wireless Local Area Network) or further, in particular radio networks, for example, can be used as the communication unit.

Since, however, the ambient sources such as sunlight or wind, for example, are not constant, permanent energy generation by the energy harvesting components is not possible. For this reason, the device additionally comprises a first storage unit 4 and a second storage unit 5, in which the electrical energy generated by the energy source 1, i.e. the energy harvesting component, can be stored.

The storage units 4 and 5 are capacitors, with the first storage unit 4 being a double-layer capacitor. Said capacitor has a very high energy density and therefore a high electrical capacitance. The second storage unit 5 is an electrolyte capacitor.

In comparison with rechargeable batteries, the capacitors, as electrical storage units, have primarily an extended life and therefore result in a high degree of reliability of the device and little complexity in terms of maintenance, which factors are very advantageous for the above-described application in poorly accessible areas. Furthermore, the capacitors are characterized by a low temperature dependence and require comparatively less complex charging circuits and methods.

The two storage units 4 and 5 have different storage capacitances, wherein the second storage unit 5, i.e. the electrolyte capacitor, has a lower storage capacitance than the first storage unit 4, i.e. the double-layer capacitor.

In accordance with the proposed method, the electrical energy generated by the energy source 1 is supplied directly to the second storage unit 5 and is stored therein.

For this charging of the second storage unit 5, a control unit 6 is provided which comprises a charging circuit 6.1, by which the supply of the electrical energy to the second storage unit 5 can be controlled. By the charging circuit 6.1, in particular an electrical voltage and an electrical current of the electrical energy drawn from the energy source 1 can be set.

In order to enable operation of the sensors at various states of charge and voltage levels of the second storage unit 5, a voltage regulator 7 is arranged between said second storage unit 5 and the sensors, by which voltage regulator 7 a voltage level of the electrical energy drawn from the second electrical storage unit 5 can be set.

For operation of the high-power electrical consumer 3, i.e. the communication unit, the energy stored in the second storage unit 5 is often insufficient, however. For this reason, the device comprises the first storage unit 4, i.e. the double-layer capacitor, which has a high storage capacitance.

Said double-layer capacitor is charged with the electrical energy stored in the second storage unit 5 by the charging circuit 6.1, with the first storage unit 4 only being charged when a minimum state of charge of the second storage unit 5 is present, said minimum state of charge being detected by a first detection unit 6.2. It is thus advantageously possible for a quantity of energy which is sufficient for the operation of the sensors to always be provided in the second storage unit 5.

In this case, the detection unit 6.2 is preferably formed as part of the control unit 6 and for example is in the form of a discrete monitoring circuit or low-power microcontroller.

The splitting into the first storage unit 4 and the second storage unit 5, i.e. into the double-layer capacitor with a high electrical capacitance and the electrolyte capacitor with a low electrical capacitance, and the electrical charging of the first storage unit 4 with electrical energy from the second storage unit 5 are performed for several reasons.

Firstly, a minimum charging current, which can exceed a current emitted by the energy source, i.e. the energy harvesting component, is required for electrically charging the double-layer capacitor. For this reason, first the electrical energy generated by the energy source 1 is stored in the second storage unit 5, the electrolyte capacitor, which is not subject to the restriction of the minimum charging current. During recharging of the electrical energy to the double-layer capacitor, much higher currents can be realized, at least temporarily, by the charging circuit 6.1, which currents at least correspond to the minimum charging current.

In this case, the charging circuit 6.1 is connected to a switching regulator 8, which is a pulsed current source. This pulsed current source has a high degree of efficiency, with the result that, advantageously, only a small proportion of the electrical energy stored in the second storage unit 5 is converted into losses during recharging to the first storage unit 4. The fact that higher currents than the minimum charging current are achieved for a short period of time during recharging is achieved by spasmodic charging of the first storage unit 4.

In order to enable operation of the electrical consumer 3 at different states of charge and voltage levels of the first storage unit 4, a voltage regulator 9 is arranged between said storage unit 4 and the consumer 3, by which voltage regulator 9 it is possible to set a voltage level of the energy drawn from the first storage unit 4.

In addition, the pulsed current source enables simultaneous charging and discharging of the second current source 5, i.e. the electrolyte capacitor. Thus, the double-layer capacitor can even be charged when electrical energy for charging the electrolyte capacitor is drawn therefrom.

A further reason for the use of the two capacitors is that the electrical voltage in the double-layer capacitor during the charging operation increases much more slowly than in the electrolyte capacitor. For operation of the low-power electrical consumers 2, however, a minimum voltage is required which is set very quickly in the electrolyte capacitor on the basis of the low storage capacitance therein.

Since the communication between the device and the control center only takes place relatively rarely, there is more time available for electrical charging of the double-layer capacitor.

The invention has been described in detail with particular reference to preferred embodiments thereof and examples, but it will be understood that variations and modifications can be effected within the spirit and scope of the invention covered by the claims which may include the phrase “at least one of A, B and C” as an alternative expression that means one or more of A, B and C may be used, contrary to the holding in Superguide v. DIRECTV, 69 USPQ2d 1865 (Fed. Cir. 2004).

1-19. (canceled)

20. A device for generation, storage and/or transmission of electrical energy, comprising:
an energy source;
a first storage unit to store electrical energy, the first storage unit being connected to high power electrical consumers of a distributed and autonomous device, the high power electrical consumers being communication units;
a second storage unit to store electrical energy, the second storage unit being connected electrically to the first storage unit in such a way that electrical energy supplied from the second storage unit can charge the first storage unit, the second storage unit having a storage capacitance less than a storage capacitance of the first storage unit, the second storage unit being connected to low power electrical consumers of a distributed and autonomous device, the low power electrical consumers being sensors; and
a control unit to control storage and/or transmission of the electrical power.

21. The device as claimed in claim 20, wherein the first storage unit and the second storage unit are of different types.

22. The device as claimed in claim 20, wherein the control unit comprises a charging circuit to control electrical energy supplied from the energy source to the second storage unit and to control electrical energy supplied from the second storage unit to the first storage unit.

23. The device as claimed in claim 20, wherein electrical energy from the energy source is directly supplied only to the second storage unit.

24. The device as claimed in claim 20, wherein the energy source is an energy harvesting component.

25. The device as claimed in claim 20, wherein the first storage unit is a double-layer capacitor.

26. The device as claimed in claim 20, wherein the second storage unit is an electrolyte capacitor.

27. The device as claimed in claim 20, further comprising:
a voltage regulator to automatically set a voltage level for operating the low-power electrical consumer.

28. The device as claimed in claim 22, wherein the control unit has a charging circuit comprising a switching regulator to charge the second storage unit, the switching regulator being a pulsed current source.

29. The device as claimed in claim 20, wherein the control circuit has a detection unit to detect a state of charge of the storage units.

30. A method for generation, storage and/or transmission of electrical energy generated by an energy source, comprising:
storing electrical energy generated by the energy source, using a first storage unit and a second storage unit, the second storage unit having a storage capacitance lower than a storage capacitance of the first storage unit;
supplying electrical energy from the energy source to the second storage unit;
charging the first storage unit with electrical energy stored in the second storage unit;
using a charging circuit of a control unit to control electrical energy transferred from the second storage unit to the first storage unit, to thereby control charging of the first storage unit;
supplying electrical energy from the first storage unit to high-power electrical consumers in the form of communication units of a distributed and autonomous device; and
supplying electrical energy from the second storage unit to low-power electrical consumers in the form of sensors of the distributed and autonomous device.

31. The method as claimed in claim 30, wherein
the control unit has a detection unit to detect a current state of charge of the second storage unit, and
the first storage unit is charged only when the current state of charge of the second storage unit exceeds a minimum state of charge.

32. The method as claimed in claim 30, wherein electrical energy is supplied to the first storage unit at the same time as electrical energy is drawn.

33. The method as claimed in claim 30, wherein electrical energy is supplied to the second storage unit at the same time as electrical energy is drawn.

34. The method as claimed in claim 30, wherein the first storage unit and/or the second storage unit supply electrical power to at least one distributed device selected from the group consisting of control devices, sensor networks, transmitters, receivers, assemblies and drives.
